(19) United States
(12) Patent Application Publication
(10) Pub. No.: US 2026/0212877 A1
(43) Pub. Date: Jul. 23, 2026

(54) VOICE ACQUISITION DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Takashi TAKAZAWA, Nisshin-shi (JP); Shuhei SHIMANOE, Nisshin-shi (JP); Yoshinori TSUCHIYA, Nisshin-shi (JP)

(21) Appl. No.: 19/368,289

(22) Filed: Oct. 24, 2025

(30) Foreign Application Priority Data
Jan. 21, 2025 (JP) 2025-008498

(51) Int. Cl. G10L 21/0216; H04R 1/02; H04R 1/08; H04R 1/28

(52) U.S. Cl. CPC G10L 21/0216; H04R 1/028; H04R 1/08; H04R 1/2876; G10L 2021/02166; H04R 2499/13

(57) ABSTRACT

The voice acquisition device to be mounted on a mobile body includes a microphone and a housing that accommodates the microphone. The housing has an opening, and an open end of the housing is joined to a plate of the mobile body via an elastic body so that the opening is covered by the plate. The microphone is accommodated in a space defined by the housing, the elastic body, and the plate.

### CROSS REFERENCE TO RELATED APPLICATION

This application is based on and claims the benefits of priority of Japanese Patent Application No. 2025-008498 filed on Jan. 21, 2025. The entire disclosure of which is incorporated herein by reference.

### TECHNICAL FIELD

The present disclosure relates to a voice acquisition device.

### BACKGROUND

A voice recognition system recognizes a voice of a speaking person present in a closed space such as a vehicle compartment.

### SUMMARY

According to at least one embodiment, a voice acquisition device to be mounted on a mobile body includes a microphone and a housing that accommodates the microphone. The housing has an opening, and an open end of the housing may be joined to a plate of the mobile body via an elastic body so that the opening is covered by the plate. The microphone may be accommodated in a space defined by the housing, the elastic body, and the plate.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram illustrating a configuration of a voice acquisition device according to a first embodiment.

FIG. 2 is a cross-sectional view of a target sound acquisition unit.

FIG. 3 is a cross-sectional view of a noise acquisition unit.

FIG. 4 is a block diagram illustrating a configuration of a signal processing unit.

FIG. 5 is a simplified model of a space enclosed by a plate-shaped member and a noise microphone housing.

FIG. 6 is a graph showing a relationship between a shape of the noise microphone housing and solid-borne propagation sensitivity.

FIG. 7 is a cross-sectional view of a miniaturized noise acquisition unit.

FIG. 8 is a table showing an amount of attenuation of transmitted sound in various materials.

FIG. 9 is a cross-sectional view of a target sound acquisition unit and a noise acquisition unit according to a second embodiment.

FIG. 10 is a cross-sectional view of a noise acquisition unit according to a third embodiment.

### DETAILED DESCRIPTION

To begin with, examples of relevant techniques will be described.

A voice recognition system recognizes a voice of a speaking person present in a closed space such as a vehicle compartment. When using the voice recognition system in the vehicle compartment, noises such as road noise are provided to a speaking microphone along with the speaking person's voice, and these noises can significantly reduce a voice recognition rate of the voice recognition system.

One method to prevent the degradation of voice recognition rate caused by the noises in the vehicle compartment is a microphone array system using multiple microphones. The microphone array system may reduce noises by utilizing a time difference between arrivals of voice signals of multiple channels input from multiple microphones, and outputs a target sound, which is the voice of a speaking person, with emphasis.

The microphone array system tends to become large in size because they incorporate a large number of microphones, and therefore miniaturization is desired. However, when a distance between microphones is reduced in order to miniaturize the microphone array system, a difference in signals between microphones becomes small for low-frequency sounds with long wavelengths. As a result, it becomes difficult for the system to extract only the target sound. In addition, since vehicle driving noise mainly consists of low-frequency sounds, it is difficult for a small microphone array system alone to sufficiently reduce the noise caused by driving noise.

On the other hand, road noise included in driving noise is transmitted as vibrations through metallic parts such as a vehicle frame, and is re-radiated as sound into the vehicle compartment from plate members such as outer steel plates. Therefore, the system can be provided with a noise microphone in addition to the microphone array. The noise microphone can acquire road noise transmitted through solid structures at an earlier timing than the microphone array can acquire the road noise. By using the road noise acquired in this way for adaptive signal processing, the system can reduce the noise.

The adaptive signal processing exhibits higher effectiveness for road noise acquired by the noise microphone when an amount of target sound input to the noise microphone is small. For example, in a comparative example according to a voice acquisition device, a sound-absorbing material made of sponge or similar material is installed around a noise microphone.

A frequency band where road noise and human voice overlap is approximately 100 Hz to 1 kHz. Therefore, in order to acquire speech while reducing the influence of road noise transmitted through a vehicle body, it is possible to effectively reduce noise by adaptive signal processing if the amount of speech input to the noise microphone is reduced for sounds in the range of 100 Hz to 1 KHz.

In the comparative example of the voice acquisition device, when sound-absorbing material is used to reduce the amount of speech input to the noise microphone, a thickness of the sound-absorbing material needs to be about one-quarter of a wavelength to enhance its effect. For sounds in the range of 100 Hz to 1 kHz, the thickness of the sound-absorbing material needs to be approximately 8.7 cm to 87 cm. However, in an actual vehicle, it is difficult to secure space to install sound-absorbing material of such thickness. Therefore, it is necessary to improve the performance of the voice acquisition device while reducing an increase in its size.

In contrast to the comparative example, according to a voice acquisition device of the present disclosure, performance can be improved while reducing an increase in size.

According to one aspect of the present disclosure, a voice acquisition device to be mounted on a mobile body includes a microphone and a housing that accommodates the microphone. The housing has an opening, and an open end of the housing is joined to a plate of the mobile body via an elastic body so that the opening is covered by the plate. The microphone is accommodated in a space defined by the housing, the elastic body, and the plate.

According to this configuration, the housing is joined to the plate via the elastic body, so that the housing vibrates relative to the plate. When vibrations of the mobile body are transmitted through the plate as solid-borne sound, the vibration of the housing causes changes in the air pressure within the space where the microphone is housed, and these changes in air pressure are detected by the microphone. This change in air pressure is correlated with the sound that is re-radiated from the plate by the vibrations of the mobile body. Therefore, it is possible to perform noise reduction by adaptive signal processing using the output signal of the microphone. According to this, by constructing the housing from a material that reflects sound waves, it is possible to suppress external sounds from entering the microphone while still allowing the microphone to capture the above-mentioned changes in air pressure. In this way, by utilizing the sound wave reflection, thick sound-absorbing material becomes unnecessary, so it is possible to improve the performance of the voice acquisition device while reducing an increase in its size.

Hereinafter, embodiments of the present disclosure will be described with reference to the drawings. In the following embodiments, the same reference numerals are assigned to parts that are the same or equivalent to each other to describe the same.

### First Embodiment

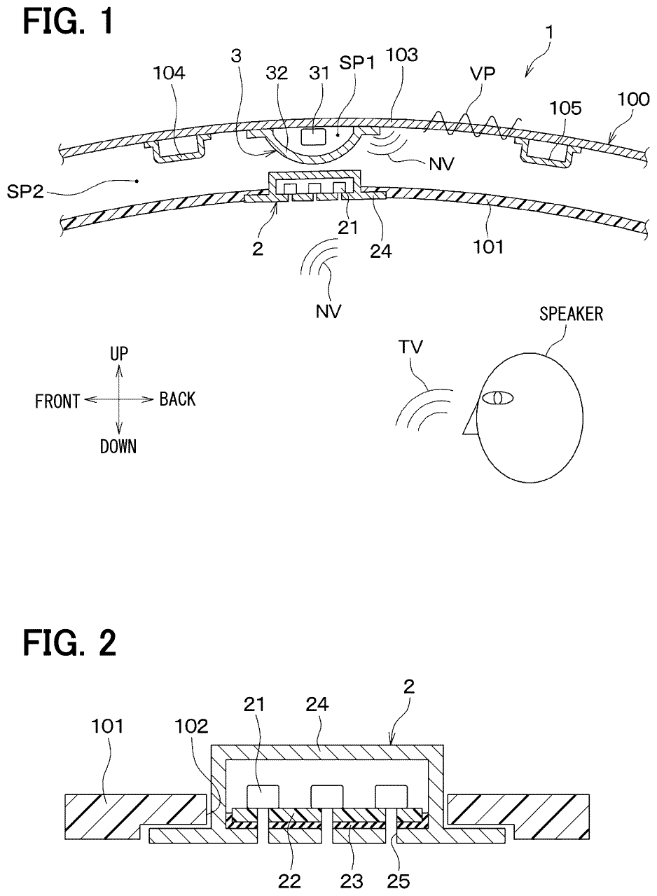

A first embodiment will be described. A voice acquisition device 1 of the present embodiment shown in FIGS. 1 to 4 is mounted on a vehicle 100 as a mobile body and is used in a voice recognition system. The voice recognition system recognizes a voice of a speaking person and transmits a control signal corresponding to the recognized voice to devices such as a navigation device or an air conditioner of the vehicle.

The voice acquisition device 1 includes a microphone module, a target sound acquisition unit 2, a noise acquisition unit 3, a signal processing unit 4, and a voice recognition engine 5. FIG. 1 shows a case where the target sound acquisition unit 2 and the noise acquisition unit 3 are provided on a ceiling of the vehicle 100. In FIG. 1, a cross-sectional view parallel to a longitudinal (front-rear) direction and a vertical (up-down) direction of the vehicle 100 is shown for the target sound acquisition unit 2, the noise acquisition unit 3, and the vehicle 100.

The target sound acquisition unit 2 acquires target sounds generated inside the vehicle 100. Here, the target sound refers to the voice of the speaking person, and the speaking person is an occupant located within a vehicle compartment, which is a closed space inside the vehicle 100. As shown in FIG. 2, the target sound acquisition unit 2 includes a speech microphone 21, a substrate 22, a separator 23, and a speech microphone housing 24. The speech microphone 21 corresponds to a second microphone. The speech microphone housing 24 corresponds to a second housing.

The speech microphone 21 is fixed to an upper surface of the substrate 22. The substrate 22 is made of, for example, glass epoxy resin or the like. The separator 23 is laminated on a lower surface and a lateral surfaces of the substrate 22. The separator 23 is made of, for example, rubber or the like.

The speech microphone housing 24 is designed to accommodate the speech microphone 21 and has a box-shaped member with an internal space. The speech microphone housing 24 is made of, for example, metal, resin, or the like.

The speech microphone 21 and the substrate 22 are fixed to a bottom surface of the speech microphone housing 24 via the separator 23. Through holes 25 is formed in a lower portion of the speech microphone 21, penetrating the substrate 22, the separator 23, and the speech microphone housing 24. The speech microphone 21 is exposed on a lower surface of the speech microphone housing 24 through the through holes 25. The through holes 25 serve as a passage for sound input to the speech microphone 21.

The speech microphone housing 24 is designed in accordance with directivity of the speech microphone 21. The through holes 25 are formed in the lower portion of the speech microphone housing 24, and this lower portion is arranged to face the vehicle compartment. The speech microphone housing 24 is fitted into a through hole 102 formed in an interior material 101. The interior material 101 constitutes a ceiling of the vehicle compartment 100 and is provided at a position where an occupant can touch it. With this arrangement of the speech microphone housing 24, the voice of an occupant inside the vehicle compartment is directly input to the speech microphone 21 through the through hole 25.

The target sound acquisition unit 2 has speech microphones 21. The speech microphones 21 are arranged in an array on an upper surface of the substrate 22, forming a microphone array. The through holes 25 are formed below each of the speech microphones 21, and the separator 23 suppresses sound that has entered one through hole 25 from leaking into other through holes 25.

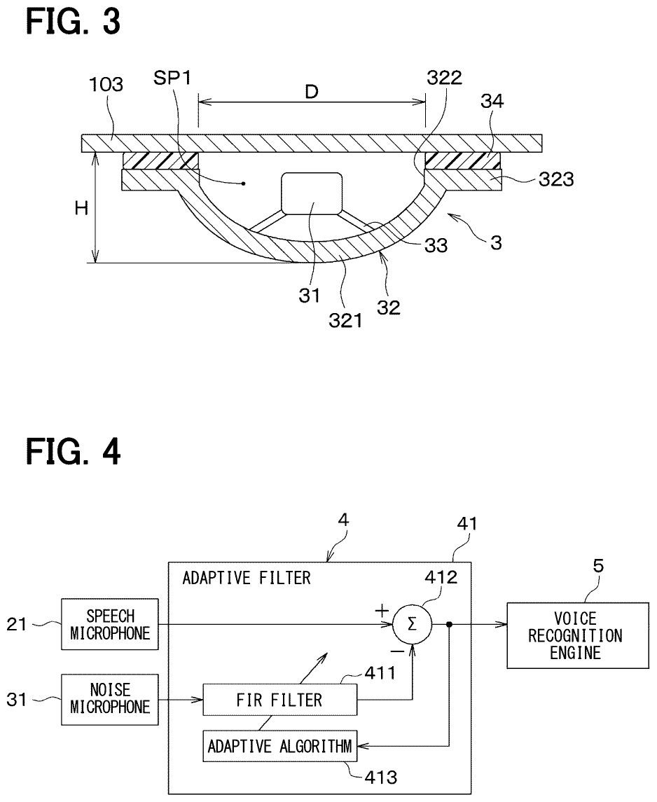

The noise acquisition unit 3 acquires noise that is different from the target sound. As described above, the target sound is the voice of the speaking person, and the noise specifically refers to, for example, traveling noise of the vehicle 100. This traveling noise propagates through solids such as a frame of the vehicle 100 and is re-emitted into the vehicle compartment where the speaking person is located. As shown in FIG. 3, the noise acquisition unit 3 includes a noise microphone 31, a noise microphone housing 32, a holding portion 33, and an elastic body (elastic member) 34. The noise microphone 31 corresponds to a first microphone. The noise microphone housing 32 corresponds to a first housing.

The noise microphone 31 outputs a signal corresponding to air pressure. The noise microphone housing 32 houses the noise microphone 31 and has an internal space. The noise microphone housing 32 has a dome portion 321 having a dome shape. A cross-section of the dome portion 321 is arcuate. The dome portion 321 has an arcuate shape in a cross section taken perpendicular to the plate member 103. A circular opening 322 is formed in the dome portion 321, and an open end 323 of the opening 322 projects in a flange shape to form a circular frame.

The noise microphone housing 32 is made of a material having a large difference in acoustic impedance compared to air. More specifically, the noise microphone housing 32 is made of a material having an acoustic impedance of 1.0×10⁶ [kg/m²s] or higher, or an acoustic impedance of 1.6×10⁷ [kg/m²s] or higher. For example, the noise microphone housing 32 is made of a metal such as aluminum, brass, or steel, or a resin such as ABS (acrylonitrile-butadiene-styrene) resin.

The holding portion 33 is a rod-shaped or plate-shaped member made of resin, rubber, or the like. Holding portions 33 are provided, with one end of each holding portion 33 joined to the noise microphone 31 and the other end joined to an inner wall of the noise microphone housing 32, thereby fixing the noise microphone 31 to the inner wall of the noise microphone housing 32 via the holding portions 33. The holding portions 33 are provided only on the noise microphone housing 32. The noise microphone 31 is supported solely by the holding portions 33. More specifically, the noise microphone 31 is fixed to a bottom portion of the dome portion 321, on a side opposite to the opening 322.

The noise microphone housing 32 is joined to a plate member 103. The plate member 103 is a plate or a plate-shaped component. Here, a case will be described in which the plate member 103 is an outer roof steel plate of the vehicle 100, but the plate member 103 may also be another member. For example, the plate member 103 may be roof glass disposed on the roof portion of the vehicle 100.

The noise microphone housing 32 is disposed between the interior material 101 and the plate member 103. As shown in FIG. 1, the plate member 103 is supported by frames 104 and 105 of the vehicle 100, and the noise acquisition unit 3 is disposed between the frame 104 and the frame 105. The frame 104 is a frame that is connected to a B-pillar of the vehicle 100.

The noise microphone housing 32 is joined to the plate member 103 via the elastic body 34, which is arranged in a circular frame shape along an upper surface of the open end 323, so that the opening 322 faces an outside of the vehicle 100. As a result, the opening 322 is covered by the plate member 103.

The elastic body 34 is formed of a viscoelastic body composed of, for example, double-sided cushion tape. A viscoelastic body is a material that possesses properties of both the viscosity of a fluid and the elasticity of a solid. As the cushion double-sided tape, products such as 3M acrylic foam tape or Amon's super-strong double-sided tape can be used.

A space enclosed by the noise microphone housing 32, the elastic body 34, and the plate member 103 is referred to as a first space SP1. The noise microphone 31 is housed within the first space SP1. A space enclosed by the interior material 101 and the plate member 103 is referred to as a second space SP2. The first space SP1 is made acoustically airtight by the noise microphone housing 32, the elastic body 34, and the plate member 103. The noise microphone housing 32 and the elastic body 34 are in close contact with each other so that sound waves do not propagate through the air as an acoustic phenomenon between the first space SP1 and the second space SP2. Similarly, the elastic body 34 and the plate member 103 are also in close contact with each other. As a result, the propagation of sound waves through the air between the first space SP1 and the second space SP2 is prevented.

As shown in FIG. 3, a height from a rear surface of the plate member 103, to which the noise microphone housing 32 is joined, to the bottom portion of the dome portion 321 is defined as H. The height H is set low so that the first space SP1 has a flat shape. More specifically, the height H is set such that, given an opening area of the opening 322 as S [mm²] and a volume of the first space SP1 as V [mm³], ta ratio V/S is 8 or less.

The speech microphones 21 and the noise microphone 31 are connected to the signal processing unit 4 by wiring (not shown). The signal processing unit 4 processes the output signal of the speech microphone 21 using the output signal of the noise microphone 31. More specifically, the signal processing unit 4 uses the output signal of the noise microphone 31 to perform processing that removes signals corresponding to noise from the output signal of the speech microphone 21.

As shown in FIG. 4, the signal processing unit 4 includes an adaptive filter 41. The adaptive filter 41 receives, as input signals, a time-series audio signal acquired by the speech microphone 21 and a time-series audio signal acquired by the noise microphone 31. The adaptive filter 41 reduces diffuse noise based on these input signals. In addition, the adaptive filter 41 improves the S/N ratio (signal-to-noise ratio).

The adaptive filter 41 includes an FIR filter 411, an adder 412, and an adaptive algorithm 413. FIR stands for Finite Impulse Response. As the adaptive algorithm, for example, an LMS algorithm or an RLS algorithm is adopted. LMS stands for least mean square, and RLS stands for recursive least square.

The FIR filter 411 adjusts the amplitude and phase of the sound signal acquired by the noise microphone 31, and outputs the adjusted sound signal to the adder 412. The adder 412 adds a sound signal obtained by inverting the adjusted sound signal input from the FIR filter 411 and the sound signal acquired by the speech microphone 21. That is, the adder 412 subtracts the sound signal acquired by the noise microphone 31 and whose amplitude and phase have been adjusted by the FIR filter 411 from the sound signal acquired by the speech microphone 21 through signal processing.

Through this processing, the audio signal output from the adder 412 is a signal in which the noise acquired by the noise microphone 31 is reduced from the audio signal acquired by the speech microphone 21, and the speaking person's voice is emphasized. The audio signal output from the adder 412 is output to both the adaptive algorithm 413 and the voice recognition engine 5. The adaptive algorithm 413 processes the audio signal output from the adder 412 and automatically changes filter coefficients of the FIR filter 411.

The signal processing unit 4 has adaptive filters 41 corresponding to the speech microphones 21. The audio signal from the noise microphone 31 is input to each adaptive filter 41, and the audio signal from each speech microphone 21 is input to the corresponding adaptive filter 41. The signal processing unit 4 reduces the noise acquired by the noise microphone 31 from the audio signals of each speech microphone 21, further reduces noise through microphone array signal processing, and outputs the result to the voice recognition engine 5. Microphone array signal processing is a process that reduces noise and emphasizes the speaking person's voice by utilizing differences in arrival times and other characteristics of multi-channel audio signals input from the speech microphones 21.

The voice recognition engine 5 mainly includes a microcontroller having a processor for performing control processing and arithmetic processing, and a memory for storing programs, data, and the like. The processor is constituted by a central processing device (i.e., CPU), MPU, or DSP (Digital Signal Processor). The memory includes various non-transient tangible storage media such as ROM, RAM, and non-volatile rewritable memory. The voice recognition engine 5 recognizes voice information indicated by the speaking person's voice based on the sound signal acquired from the signal processing unit 4, and outputs a control signal corresponding to the voice information to various in-vehicle devices such as a navigation device or an air conditioner.

The operation of the voice acquisition device 1 will be described. In the voice acquisition device 1, as shown in FIG. 1, when the speaking person utters the voice TV, the voice TV passes through the through holes 25 and is input to the speech microphone 21. The speech microphone 21 outputs a signal corresponding to the voice TV, and the output signal from the speech microphone 21 is input to the voice recognition engine 5 via the signal processing unit 4, where it is used for operations such as navigation devices.

At this time, when vibration VP is generated in the plate member 103 due to the traveling of the vehicle 100, noise NV is re-emitted from the plate member 103 into the second space SP2 and the vehicle compartment by the vibration VP. In the target sound acquisition unit 2, the noise NV, like the voice TV, passes through the through holes 25 and is input to the speech microphone 21.

On the other hand, in the noise acquisition unit 3, since the first space SP1 is kept airtight, the noise NV does not propagate directly to the noise microphone 31. However, since the noise microphone housing 32 is joined to the plate member 103 by the elastic body 34, the vibration VP propagates as a solid to the noise microphone housing 32. At this time, the elastic body 34 deforms, and the noise microphone housing 32 vibrates relative to the plate member 103. As a result, the air pressure in the first space SP1 changes. The noise microphone 31 outputs a signal in response to this change in air pressure. That is, the noise microphone housing 32 converts the vibration VP into changes in the air pressure of the first space SP1, and the noise microphone 31 indirectly acquires the noise NV through changes in air pressure that are correlated with the noise NV.

The output signal of the noise microphone 31 is input to the signal processing unit 4, where the adaptive filter 41 reduces signals correlated with the noise NV from the output signal of the speech microphone 21. As a result, the speech recognition accuracy in the voice recognition engine 5 is improved.

In order to accurately remove the signal corresponding to the noise NV from the output signal of the speech microphone 21 in the signal processing unit 4, it is necessary to improve the detection sensitivity of vibration VP in the noise microphone 31. The inventors of the present invention investigated a relationship between a shape of the first space SP1 and the detection sensitivity of the vibration VP in the noise microphone 31.

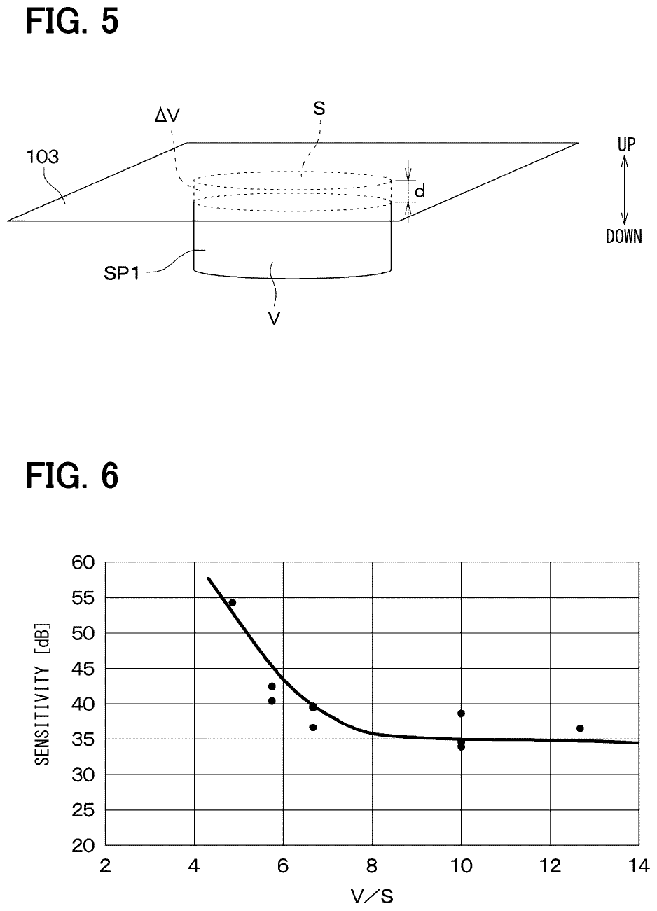

The first space SP1 can be represented by a simplified model as shown in FIG. 5. That is, the first space SP1 can be represented as a cylindrical space having a base area S and a volume V. The amplitude of the vibration of the noise microphone housing 32 caused by vibration VP is defined as “d”. A direction in which the amplitude d moves away from the plate member 103, that is, downward in the vehicle 100 in the present embodiment, is defined as positive. In addition, the amplitude d is assumed to be infinitesimal. The change in volume ΔV of the first space SP1 due to the amplitude d is expressed by Equation (1).

$$\begin{matrix}〈 Math 1 〉 & \\ Δ V = - Sd & ( 1 )\end{matrix}$$

At this time, the air pressure in the first space SP1 is “P”, the change in pressure P during the adiabatic process is “ΔP”, and a specific heat ratio is “γ”, Equation (2) holds.

$$\begin{matrix}〈 Math 2 〉 & \\ {PV}^{γ} = ( P + Δ P ) {( V + Δ V )}^{γ} & ( 2 )\end{matrix}$$

Dividing both sides of Equation (2) by PV^{Y} and rearranging using ΔV<<V, Equation (3) is obtained.

$$\begin{matrix}〈 Math 3 〉 & \\ \begin{matrix}1 = ( 1 + \frac{ΔP}{P} ) {( 1 + \frac{Δ V}{V} )}^{γ} \\ ≅ ( 1 + \frac{ΔP}{P} ) ( 1 + γ \frac{Δ V}{V} ) \\ = 1 + \frac{Δ P}{P} + γ \frac{Δ V}{V} + γ \frac{Δ P Δ V}{PV}\end{matrix} & ( 3 )\end{matrix}$$

By neglecting second and higher order minute quantities, assuming that the air pressure P is constant at atmospheric pressure and γ is constant for air, Equation (4-1) is obtained from Equations (1) and (3).

$$\begin{matrix}〈 Math 4 〉 & \\ Δ P \approx - γ P \frac{Δ V}{V} & ( 4 - 1 )\end{matrix}$$

$$∝ \frac{s}{v} d \qquad ( 4 - 2 )$$

That is, shown Equation (4-2), vibration with amplitude d is converted into a change in air pressure ΔP, which is the sound pressure, by a gain of S/V. To increase this gain, the opening area S should be increased and the volume V should be decreased. By making the first space SP1 flat, the gain increases and the detection sensitivity of vibration VP in the noise acquisition unit 3 is improved.

Multiple plots in FIG. 6 show experimental results obtained by the inventors. In this experiment, the diameter D of the opening 322 was set to 20 mm or 30 mm, and the detection sensitivity of vibration VP in the noise microphone housing 32, which was manufactured with various values of V/S, was measured. A solid line in FIG. 6 is an approximation curve of the multiple plots. In this experiment, the noise microphone housing 32 is made of brass, and the frequency of the vibration VP is set to 100 Hz to 1 KHz.

In a case where the opening area S is small relative to the volume V, and the diameter D is constant, the mass of the noise microphone housing 32 increases. As a result, it was confirmed that the sensitivity of the noise microphone housing 32 tends to become saturated. On the other hand, in a range where V/S is approximately 8.0 or less, the sensitivity improved as V/S decreased. This is considered to be the effects of increasing the opening area S and decreasing the volume V as described above.

In practical terms, it is preferable for the noise microphone housing 32 to be as small as possible, however, if the mass of the noise microphone housing 32 is too small, the detection sensitivity for vibration VP decreases. Contrary to this, by setting V/S to 8 or less, it is possible to compensate for the decrease in detection sensitivity when miniaturizing the noise microphone housing 32.

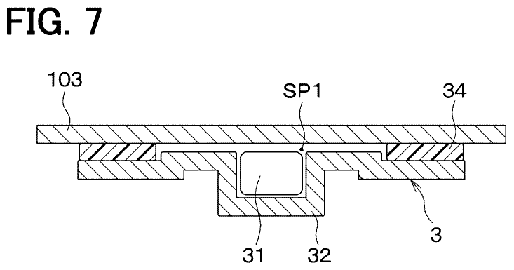

It should be noted that V/S represents an average height of the first space SP1. In order to reduce the volume V, the inner wall of the noise microphone housing 32 may be designed to conform to the shape of the noise microphone 31, as shown in FIG. 7. In this case, the average height of the first space SP1 is defined by the clearance between the plate member 103 and the surface of the noise microphone 31, as well as the inner wall of the noise microphone housing 32. If the average height becomes less than 0.1 mm, the plate member 103 may come into contact with the noise microphone 31 or the noise microphone housing 32 when it vibrates significantly, resulting in different characteristics. Therefore, it is desirable to set V/S to 0.1 or more.

In order to achieve the effects of improved detection sensitivity when V/S≤8, it is desirable that the noise microphone housing 32 and the plate member 103 vibrate independently from each other, and that the airtightness of the first space SP1 is maintained. To achieve this, it is necessary to join the noise microphone housing 32 and the plate member 103 with an elastic body that can deform while maintaining airtightness. In addition, if a material with a simple linear spring constant is used as the elastic body, there is a possibility that the noise microphone housing 32 may resonate with respect to the vibration VP. If the noise microphone housing 32 does not resonate, there is a tendency for the impulse response to become prolonged, which may increase the number of taps required for the adaptive filter processing in the signal processing unit 4 and thereby reduce processing efficiency. Therefore, it is desirable to use a viscoelastic material containing a resistive component, that is, a damping component, as the elastic body 34.

In order to efficiently remove the signal corresponding to noise vibration NV from the audio signal of the speech microphone 21 in the signal processing unit 4, it is desirable to suppress the input of target voice TV to the noise microphone 31. There are two possible methods for this in the noise microphone housing 32, a method of absorbing the target voice TV and a method of reflecting the target voice TV. In the sound-absorbing method, it is necessary to increase a thickness of the sound-absorbing material according to the frequency of the human voice, which may result in an increase in an overall size of the voice acquisition device 1.

In contrast, in the present embodiment, the input of speech TV to the noise microphone 31 is suppressed by using reflection. More specifically, the noise microphone housing 32 is made of a material that has a large difference in acoustic impedance compared to air. The acoustic impedance is an intrinsic property of a material, defined as the product of the speed of sound and its density.

The reflection of sound occurs due to differences in acoustic impedance at boundary surfaces. More specifically, when a sound wave is incident from a first medium to a second medium, if the acoustic impedance of the first medium is Z1 and that of the second medium is Z2, a transmission coefficient T of the sound wave is expressed by Equation (5).

$$\begin{matrix}〈 Math 5 〉 & \\ τ = \frac{2 {Z}_{1}}{{Z}_{1} + {Z}_{2}} & ( 5 )\end{matrix}$$

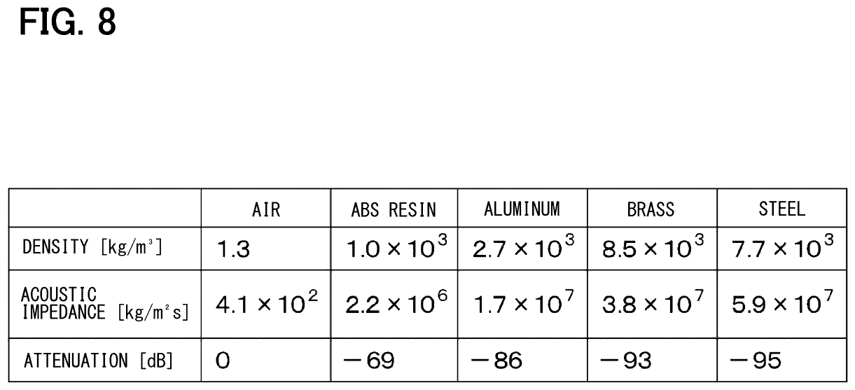

In the present embodiment, when a sound wave enters the noise microphone housing 32 from the second space SP2, the first medium is air, so the acoustic impedance Z1 can be regarded as a constant. The second medium is the material of the noise microphone housing 32, and the greater the acoustic impedance Z2, that is, the acoustic impedance of the noise microphone housing 32, the lower the transmission coefficient T. As an example, FIG. 8 shows density and acoustic impedance of various materials, as well as an attenuation amount of transmitted sound in the noise microphone housing 32 made from each of those materials.

As shown in FIG. 8, the acoustic impedances of ABS resin, aluminum, brass, and steel are 2.2×10⁶ [kg/m²s], 1.7×10⁷ [kg/m²s], 3.8×10⁷ [kg/m²s], and 5.9×10⁷ [kg/m²·s], respectively. By constructing the noise microphone housing 32 from these materials, the voice TV transmitted to the noise microphone 31 can be attenuated by 69 [dB], 86 [dB], 93 [dB], and 95 [dB], respectively, due to reflection within the noise microphone housing 32. Note that, although ABS resin is exemplified in FIG. 8, the noise microphone housing 32 may be made of other resins. Additionally, the noise microphone housing 32 may be made of metals other than aluminum, brass, or steel.

As sound-absorbing materials, GW (glass wool) products such as Paraboard series from Paramount Glass Industry Co., Ltd. are known. For example, the attenuation of 1 [KHz] sound is 7.9 [dB] for GW with a density of 96 [kg/m³] and a thickness of 25 [mm], and 6.7 [dB] for GW with a density of 32 [kg/m³] and a thickness of 50 [mm], with respective sound absorption coefficients of 0.96 and 1.02. In the present embodiment, which attenuates the voice TV by using reflection, a high attenuation rate can be achieved while suppressing the increase in size of the noise microphone housing 32, compared to using a sound-absorbing material.

Additionally, since the noise microphone housing 32 is not fixed within the second space SP2 by any member other than the elastic body 34, it undergoes coupled vibration with the plate member 103 via the elastic body 34. At this time, the greater the mass of the noise microphone housing 32, the more it tends to remain stationary in the space due to its inertia. As a result, the amplitude d of the relative motion with respect to the plate member 103 increases, and the change ΔP in air pressure P becomes larger, thereby improving the detection sensitivity of the vibration VP. From this perspective as well, it is desirable to construct the noise microphone housing 32 from a high-density material such as metal.

As described above, in the present embodiment, the noise microphone housing 32 is in contact with the plate member 103 via the elastic body 34. As a result, the noise microphone housing 32 vibrates relative to the plate member 103. When the vibration VP propagates through the plate member 103 as a solid, the vibration of the noise microphone housing 32 causes the air pressure in the first space SP1 to change, and this change in air pressure is detected by the noise microphone 31. This change in air pressure is correlated with the noise NV that is re-radiated from the plate member 103 by the vibration VP. Therefore, it is possible to perform noise reduction by adaptive signal processing using the output signal of the noise microphone 31. Furthermore, by constructing the noise microphone housing 32 from a material that reflects sound waves, it is possible to acquire the change in air pressure of the first space SP1 with the noise microphone 31, while reducing external sounds from entering the noise microphone 31. For example, it is possible to reduce the entry of the speaking person's voice, which is transmitted through the air, into the noise microphone 31. In this way, by utilizing the sound wave reflection, thick sound-absorbing material becomes unnecessary, so it is possible to improve the performance of the voice acquisition device 1 while reducing an increase in its size.

According to the embodiment described above, it is possible to achieve the following advantageous effects.

The noise microphone housing 32 is composed of a material having an acoustic impedance of 1.0×10⁶ [kg/m²s] or more. With this configuration, it is possible to reduce the transmission of the voice signal TV to the noise microphone 31 by utilizing the sound wave reflection, and to improve performance while reducing an increase in the size of the noise microphone housing 32.

The noise microphone housing 32 is composed of a material having an acoustic impedance of 1.6×10⁷ [kg/m²s] or more. Accordingly, it is possible to further reduce the transmission of the voice TV to the noise microphone 31.

The V/S is 8 or less. Accordingly, when the noise microphone housing 32 is miniaturized, it is possible to compensate for the detection sensitivity.

The elastic body 34 is formed of a viscoelastic material. Accordingly, it becomes possible to vibrate the noise microphone housing 32 and the plate member 103 separately while maintaining the airtightness of the first space SP1, thereby further enhancing the effects of improving the detection sensitivity. In addition, it is possible to reduce resonance of the noise microphone housing 32. Furthermore, it is possible to suppress an increase in the number of taps required for the adaptive filter processing in the signal processing unit 4, and to prevent a decrease in efficiency.

The first space SP1 is made airtight by the noise microphone housing 32, the elastic body 34, and the plate member 103. Accordingly, the effects of improving the detection sensitivity can be enhanced.

### Second Embodiment

A second embodiment will be described. The present embodiment changes the configuration of the speech microphone housing 24 and the noise microphone housing 32 compared to the first embodiment. Since the other configurations are the same as those of the first embodiment, only the differences from the first embodiment will be described.

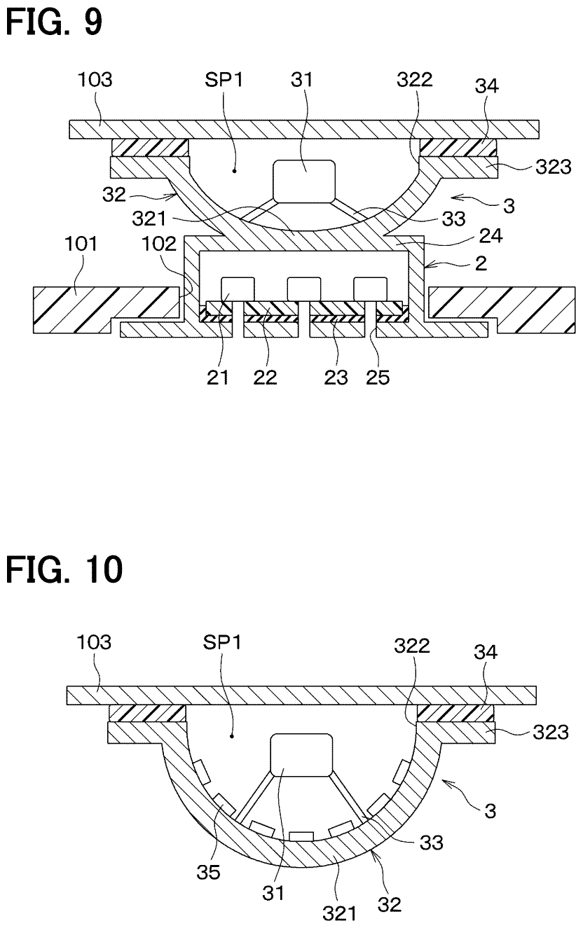

As shown in FIG. 9, the speech microphone housing 24 of the present embodiment is integrally formed with the noise microphone housing 32. More specifically, a bottom portion of a dome portion 321 is joined to an upper surface of the speech microphone housing 24 so that an opening 322 and through holes 25 are open on opposite sides to each other. FIG. 9 shows a case where the speech microphone housing 24 and the noise microphone housing 32 are integrally molded from the same material. However, the speech microphone housing 24 and the noise microphone housing 32 may be molded separately and then joined. In addition, the speech microphone housing 24 and the noise microphone housing 32 may be made of different materials.

By integrally forming the noise microphone housing 32 with the speech microphone housing 24, it is possible to assemble the speech microphone housing 24 and the noise microphone housing 32 in a single step. This configuration improves assemblability. For example, the assembly of the speech microphone housing 24 and the noise microphone housing 32 may be performed in the process of assembling the plate member 103 or in the process of assembling wire harnesses to the plate member 103. Alternatively, the assembly may be performed in the process of assembling the interior material 101 to the inside of the plate member 103.

In order to reduce the input of the noise vibration NV to the speech microphone 21 caused by the vibration of the speech microphone housing 24 together with the noise microphone housing 32, a cushion may be provided between the speech microphone housing 24 and the noise microphone housing 32. Alternatively, by integrally molding the speech microphone housing 24 with the noise microphone housing 32 and firmly fixing it to the noise microphone housing 32, and by increasing the mass of the noise microphone housing 32, the inertial force of the noise microphone housing 32 increases, resulting in a greater amount of change ΔP due to relative vibration with respect to the plate member 103. As a result, the detection sensitivity for vibration VP can be improved.

The present embodiment can achieve the same effects as those of the first embodiment from the same configuration and operation as those of the first embodiment.

In addition, according to the above embodiment, the following effects can be obtained.

The speech microphone housing 24 is integrally formed with the noise microphone housing 32. Accordingly, it is possible to improve the assemblability.

### Third Embodiment

A third embodiment will be described. The present embodiment is a modification in which a configuration of the noise acquisition unit 3 is modified from the first embodiment. Since the present embodiment is similar to the first embodiment in the other aspects, only an aspect different from the first embodiment is described.

As shown in FIG. 10, in the noise acquisition unit 3 of the present embodiment, a sound absorbing portion 35 is provided inside the noise microphone housing 32. The sound absorbing portion 35 is made of a porous material or fibrous material having a sound-absorbing effect, and a portion of the inner wall of the dome portion 321 is covered by the sound absorbing portion 35. In FIG. 10, the sound absorbing portion 35 is arranged in multiple locations, but it may be arranged in only one location. The sound absorbing portion 35 may also be provided with a wedge structure having a sound-absorbing effect, an acoustic metamaterial, or the like.

By providing the sound absorbing portion 35 inside the noise microphone housing 32, it is possible to reduce multiple reflections of sound waves on the inner wall of the noise microphone housing 32 and reduce resonance. In addition, the reduction of resonance improves the noise reduction effect by the adaptive filter 41.

The present embodiment can achieve the same effects as those of the first embodiment from the same configuration and operation as those of the first embodiment.

According to the above embodiment, the following advantageous effects can be obtained.

A sound absorbing portion 35 is arranged inside the noise microphone housing 32. Accordingly, resonance in the noise microphone housing 32 can be reduced, and the noise reduction effect can be improved.

### Other Embodiments

In the third embodiment, the speech microphone housing 24 may be integrally formed with the noise microphone housing 32, as in the second embodiment. The voice acquisition device 1 may not include one or more of the target sound acquisition unit 2, the signal processing unit 4, or the voice recognition engine 5, and these components may be provided by another device. The noise microphone housing 32 may be made of a material having an acoustic impedance of less than 1.0×10⁶ [kg/m²s]. The V/S ratio may be greater than 8. The cross-section of the noise microphone housing 32 does not have to be arcuate. The opening 322 does not have to be circular. The voice acquisition device 1 may be mounted on a mobile body other than a vehicle.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A voice acquisition device to be mounted on a mobile body, comprising:
a microphone; and
a housing accommodating the microphone, wherein
the housing has an opening,
an open end of the housing is joined to a plate of the mobile body via an elastic body such that the opening is covered by the plate, and
the microphone is accommodated in a space defined by the housing, the elastic body, and the plate.

2. The voice acquisition device according to claim 1, wherein
a material of the housing has an acoustic impedance of at least 1.0×10⁶ kg/m²s.

3. The voice acquisition device according to claim 1, wherein
a material of the housing has an acoustic impedance of at least 1.6×10⁷ kg/m²s.

4. The voice acquisition device according to claim 1, wherein
a volume of the space is V [mm³],
an opening area of the opening is S [mm²], and
a ratio V/S is 8 or less.

5. The voice acquisition device according to claim 4, wherein
the housing has an arcuate shape in a cross section.

6. The voice acquisition device according to claim 4, wherein
the opening is circular.

7. The voice acquisition device according to claim 1, wherein
the elastic body is formed of a viscoelastic material.

8. The voice acquisition device according to claim 1, wherein
the space is hermetically sealed by the housing, the elastic body, and the plate.

9. The voice acquisition device according to claim 1, wherein
the mobile body is a vehicle, and
the plate is an outer steel plate or a roof glass constituting at least a part of a ceiling of the vehicle.

10. The voice acquisition device according to claim 1, further comprising:
a second microphone; and
a processor having a memory storing computer program code executable by the processor, wherein
the microphone is a first microphone, and
the processor is configured to process an output signal of the second microphone using an output signal of the first microphone.

11. The voice acquisition device according to claim 10, wherein
the second microphone is configured to acquire a voice of a speaking person,
the second microphone is one of second microphones,
the second microphones constitute a microphone array,
the first microphone is configured to acquire noise different from the voice, and
the processor is configured to remove a signal corresponding to the noise from output signals of the second microphones using the output signal of the first microphone.

12. The voice acquisition device according to claim 10, further comprising:
a second housing accommodating the second microphone, wherein
the housing is a first housing, and
the second housing is integrally formed with the first housing.

13. The voice acquisition device according to claim 1, wherein
a sound absorbing portion is disposed inside the housing.

14. The voice acquisition device according to claim 4, wherein
the housing has an arcuate shape in a cross section taken perpendicular to the plate.
